(19) United States
(12) Patent Application Publication
(10) Pub. No.: US 2007/0199652 A1
(43) Pub. Date: Aug. 30, 2007

(54) Compensating Device And A Method And A Machine For Using It

(76) Inventor: Per Gustafsson, Bjarred (SE)

Correspondence Address: BIRCH STEWART KOLASCH & BIRCH, PO BOX 747, FALLS CHURCH, VA, 22040-0747, US

(21) Appl. No.: 10/591,711

(22) PCT Filed: Mar. 23, 2005
(86) PCT No.: PCT/SE05/00436

§ 371 Date: Sep. 6, 2006

(30) Foreign Application Priority Data
Mar. 26, 2004 (SE) 0400785-2

(51) Int. Cl. B32B 37/00; B32B 37/10; B29C 65/00; B30B 15/34

(52) U.S. Cl. 156/304.1; 156/581; 156/583.1; 156/583.3; 156/304.6

(57) ABSTRACT

The invention relates to a device (1) for producing container blanks (2) from a material web (3), which container blanks in the filled state form container of a collapsible type, said device comprising at least one sealing tool (7) with an extended rib (9), the sealing tool (7) being movable to bring the rib (9) into engagement with the material web (3) for joining opposite wall portions of the material web (3). The device is characterised by a compensating means (14) for ensuring abutment of the rib (9) along its entire length against the material web (3). The invention also relates to a method and a machine for producing container blanks.

### FIELD OF THE INVENTION

The present invention relates to a method and a device for producing container blanks from a material web, which container blanks in the filled state form containers of a collapsible type. The device comprises at least one sealing tool with an extended rib, the sealing tool being movable to bring the rib into engagement with the material web for joining opposite wall portions of the material web.

### BACKGROUND ART

For the container blanks to form containers which in the filled state are liquid-tight, it is important for the connecting portions of the container blanks to be reliable. The reliability of the connecting portions depends on, inter alia, the accuracy with which the sealing process is carried out and the period of time during which the sealing process is allowed to take place.

WO99/41155 discloses a device for making container blanks by joining opposite wall portions of a material web along connecting portions.

The material web comprises two side wall webs which are passed in a parallel opposite relationship along a manufacturing line and, between them, a bottom wall web folded in two. The webs are thus brought together to a common material web and sealed to each other along said connecting portions by means of heating jaws of the device, which tools engage the material web.

According to prior art, the material web is fed to different stations, at which sealing takes place.

A small part of the connecting portion of a container blank is formed with an overlap at each station. The reason why the sealing occurs at several stations is that up to now it has not been possible to provide a device which with a satisfactory result manages the provision of the entire connecting portion in one step at one station. It has in fact been found that the device and its sealing tool engaging the material web in operation are influenced by a number of factors which upset the initial setting of the device.

These factors comprise, inter alia, thermally conditioned changes in shape and motions in the device and its sealing tool as a result of the heat generated in the sealing tool to provide said sealing, changes in the setting of the device and its tool as a result of the motion of the device in operation and also changes in said setting due to wear or outer influence, such as impacts or shocks.

Consequently, it is not possible to ensure that the tool is applied to the material web in a correct manner. If the tool is designed so as to provide the forming of an entire connecting portion, this results in the fact that the sealing tool along certain portions can be applied too forcefully to the material web and, along others, too softly. This means in turn that the connecting portion will not be able to exhibit the necessary reliability.

The solution to the problem indicated by prior-art technique thus comprises making said connecting portion step by step with an overlap at successive stations. As a result, the device will be less sensitive to influence by the above-mentioned factors. However, other problems may arise in some cases.

One problem could be that the sealing process takes relatively long.

Moreover the successive sealing operations result in a relatively intense exposure to heat, and as a consequence heating of the material. When the material web is fed to the last stations, it may happen that the material web is deformed by stretching, which results in deviations in shape of the container blanks. For obvious reasons, this may cause problems in connection with filling of the container blanks in a filling machine.

Another problem associated with stepwise production of container blanks is that the process necessitates accurate synchronisation and, thus, complicated adjustment of the machine and the material web.

There is thus a need for an alternative method which allows simple and reliable production of container blanks.

### SUMMARY OF THE INVENTION

The object of the present invention is to provide, in view of that stated above, an alternative device and an alternative method for producing container blanks by joining opposite wall portions of a material web along a connecting portion.

A further object is to provide such a device and method which allow easy and reliable production of container blanks of the type mentioned.

Another object of the present invention is to provide such a device and method which allow rational production of container blanks.

It is also an object of the invention that the device and method allow production of container blanks with reliable connecting portions.

To achieve at least one of the above objects and also other objects that will be evident from the following description, there are provided according to the present invention a device having the features stated in claim 1, a method having the features stated in claim 15 and a machine having the features stated in claim 17. Embodiments of the device will be evident from claims 2-14 and embodiments of the method will be evident from claim 16.

More specifically, according to the present invention a device, and a machine comprising such a device, for producing container blanks from a material web is provided, which container blanks in the filled state form containers of a collapsible type, said device comprising at least one sealing tool with an extended rib, the sealing tool being movable to bring the rib into engagement with the material web for joining opposite wall portions of the material web. The device is characterised by a compensating means for ensuring abutment of the rib along its entire length against the material web.

The inventive device is thus based on the concept of using a compensating means to ensure that the rib abuts along its entire length against the material web. This results in a device, in which a sealing tool can establish a reliable and safe seal along the entire connecting portion of a container blank.

As described by way of introduction, there are a number of different factors which in operation can affect the setting of the device and its sealing tool. Because the device comprises a compensating means, which in the sealing process ensures that the rib along its entire length abuts against the material web, it is ensured that the accuracy that is necessary for reliable sealing is maintained in operation, also in the case that the device and its tool have deviated from their initial setting. This makes it possible to design the tool so that it can provide, at a single station, the forming of an entire connecting portion.

In the case that the device and its sealing tool have deviated from their initial setting, the compensating means performs compensation of the sealing tool so that its rib along its entire length is made to abut against the material web, which enables the forming of a reliable connecting portion. Since the sealing can be performed in one step, the time required to form an entire connecting portion is reduced, which in turn results in improvement of the production capacity of the device.

By each connecting portion being formed in one step, the exposure to heat to which the material web is subjected is reduced, which in turn means that the material web will be less prone to deformation by stretching.

Owing to the compensating means, the device does not require a complicated mechanism for synchronisation of different sealing tools.

The rib can be arranged to form a connecting portion of the container blank which at least defines a compartment of the container blank.

According to one embodiment of the inventive device, the compensating means is arranged to provide a contact pressure against the material web, the contact pressure varying along the extent of the rib of the at least one sealing tool. This makes it possible to take the number of layers in the material web into consideration so as to optimise sealing to provide a reliable connecting portion.

According to another embodiment, the at least one sealing tool of the device is suspended from the compensating means. The suspension gives the advantage that the compensating means can perform, without any intermediate steps, its compensation of the sealing tool so that its rib along its entire length is made to abut against the material web.

According to a further embodiment, the compensating means is in the form of a spring assembly, which may comprise pressure springs for instance. A compensating means comprising such a spring assembly can effectively be made to perform the compensation of the tool when its rib is made to abut against the material web. Any deviations in the setting of the device and its tool are taken up by the spring assembly, so that the rib is applied to the material web in the intended way. The spring assembly also makes it possible to easily provide the desired sealing pressure. This can be achieved, for example, by the spring assembly being arranged for a predetermined compression during the sealing process.

The spring assembly may comprise spring elements with mutually different spring constants, whereby a contact pressure, varying along the extent of the rib, against the material web can easily be provided.

To increase the sensitivity of the spring assembly, it can be biased.

The compensating means can be arranged along the edge portions of the sealing tool. The location of the compensating means makes it possible to reduce the size of the compensating means while at the same time it performs the necessary compensation. For example, a smaller number of springs can be used to perform a certain compensation of the sealing tool if they are arranged along edge portions compared with the case that the springs are arranged along the entire sealing tool. The location along edge portions also gives the advantage that stronger springs can be used.

According to yet another embodiment, the device comprises a base element, from which the at least one sealing tool is suspended via the compensating means. Such a base element can serve as a base for a plurality of sealing tools of the type described above, which means that the device can easily be made to exhibit an additionally increased capacity.

A number of pins can be arranged on the side of the sealing tool which faces the base element and the base element can comprise a number of through holes, the pins extending through said holes and said spring elements being arranged around the pins and positioned between the sealing tool and the base element.

The pins can support stop washers at the ends extending through the holes of the base element.

The device may further comprise an abutment, which is arranged on the opposite side of the material web to cooperate with the sealing tool for joining opposite wall portions of the material web.

The abutment can have a shape complementary to the sealing tool.

The sealing tool can, for instance, be turnably arranged to be pivoted downwards, be vertically movable or rotatable to be brought into engagement with the material web.

According to the invention, also a method for producing container blanks from a material web is provided, which container blanks in the filled state form containers of a collapsible type. The method is characterised by arranging a material web with wall portions, abutting against each other, between a sealing tool and an abutment, which sealing tool comprises a rib having an extent corresponding to the connecting portions of a container blank, bringing said rib into abutment against the material web for clamping the same between said rib and said abutment, compensating for the abutment of the rib so that the rib abuts against the material web along its entire extent, and joining, by means of said rib, said opposite wall portions to each other along a connecting portion.

This results in a method which in an easy and reliable way can produce container blanks with reliable connecting portions.

The method results in each connecting portion being provided in one step, which gives the advantages that have been mentioned above in connection with the above-described device for producing container blanks.

According to one embodiment of the inventive method, the step of compensating for the abutment of the rib is performed by means of a spring assembly, from which said sealing tool is suspended and which in connection with the step of bringing the tool into abutment against the material web compensates for deviations in the initial setting of the tool.

### BRIEF DESCRIPTION OF THE DRAWINGS

The invention will now be described in more detail with reference to non-limiting embodiments with reference to the accompanying drawings.

FIG. 1 is a schematic perspective view of an inventive device for producing container blanks from a material web.

FIG. 2 is a cross-sectional view of the device shown in FIG. 1 along line II-II and illustrates a sealing tool of the device in engagement with the material web.

FIGS. 3 and 4 are side views of an inventive device that have been actuated so that the device and its tool have deviated from their initial setting.

FIG. 5 is a cross-sectional view taken along line V-V in FIG. 1.

### DESCRIPTION OF A PREFERRED EMBODIMENT

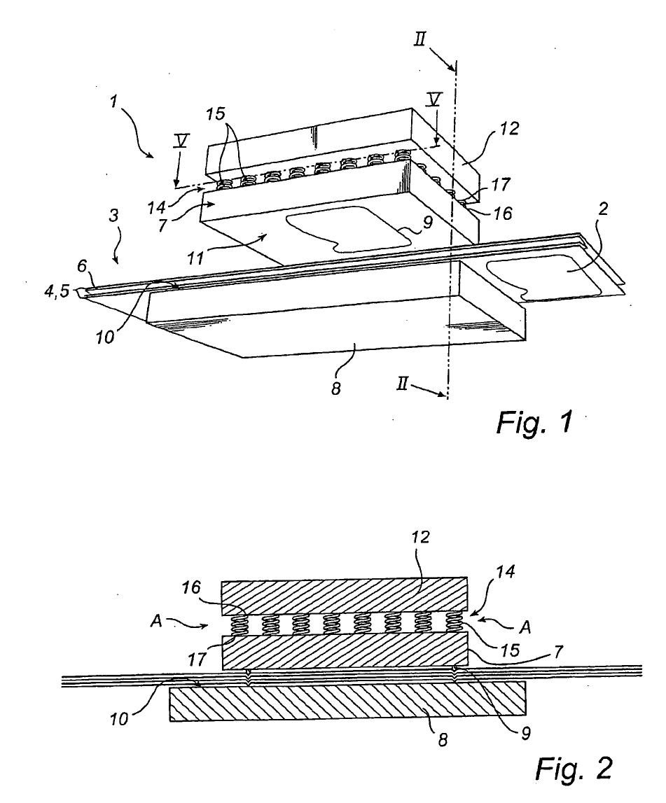

FIG. 1, to which reference is now made, illustrates schematically an embodiment of an inventive device 1 for producing container blanks 2 from a material web 3.

The device 1 in FIG. 1 comprises a sealing tool 7, a base element 12 and a compensating means 14. The device 1 is arranged to cooperate with a material web 3 and an abutment 8.

The sealing tool 7 supports in the shown embodiment a profile structure 11 facing the abutment 8. The profile structure 11 comprises more specifically a projecting rib 9 which has an extent corresponding to a connecting portion. The rib 9 is arranged to engage the material web 3 and, in cooperation with a heating means (not shown), provide a connecting portion in the container blank 2 by heat sealing. It will be appreciated that the present invention is not limited to heat sealing but can be used in cooperation with different sealing techniques, such as ultrasonic sealing. It will also be appreciated that the extent of the rib 9 does not have to correspond to an entire connecting portion; for instance, the rib can correspond to one part of a first container blank 2 and a second part of a second container blank 2. However, it is preferred to design the rib 9 so that its extent corresponds at least to that part of a connecting portion which defines a compartment of a container blank 2.

FIGS. 1-4 show the base element 12 of the device 1. In the embodiment shown, the base element 12 is a rectangular plate. The sealing tool 7 and the base element 12 are spaced apart and the compensating means 14 is arranged between them.

The compensating means 14 comprises in the embodiment shown in FIGS. 1-4 a number of pressure springs 15. The pressure springs 15 are at their one ends 17 attached to the sealing tool 7 and at their other ends 16 attached to the base element 12. The sealing tool 7 and the base element 12 are thus interconnected by the pressure springs 15 of the compensating means 14. The pressure springs 15 can be biased between the sealing tool 7 and the base element 6.

In one embodiment (not shown) the sealing tool 7 is provided with a number of pins on its side facing the base element. The pins extend through holes which are formed in the base element 12. The pins can support stop washers at the ends extending through the holes in the base element 12.

The springs are arranged around the pins and located between the sealing tool and the base element. The springs can be biased, the magnitude of the bias being adjusted by the positioning of said stop washers.

It will be appreciated that the compensating means 14 can be provided in other ways than by pressure springs; for instance spring steel, cup springs or rubber material can be used.

The base element 12 is movably arranged so that the sealing tool 7 supported thereby via said compensating means 14 is applicable to said abutment 8, whereby the rib 9 of the sealing tool 7 can be brought into engagement with a material web 3 arranged between the sealing tool 7 and abutment 8.

The base element 12 can be movably arranged so that the pressure springs 15 of the compensating means 14 are compressed in connection with the engagement of said rib 9 with the material web 3.

In the initial setting of the inventive device, the pressure springs 15 are arranged for a predetermined compression, whereby the required sealing pressure can be provided by selecting a suitable spring constant and/or bias of the pressure springs 15.

However, it is also conceivable to arrange the inventive device so that the base element 12 applies a pressure to the pressure springs 15 which in turn transfer the pressure to the sealing tool 7 and the material web 3 without compression of the pressure springs 15 occurring in the initial setting of the device.

The pressure springs 15 can have mutually different spring constants. This makes it possible to provide a contact pressure, varying along the extent of the rib 9, against the material web 3. As a result, any varying number of material layers in the material web 3 can be taken into consideration and, consequently, the sealing process can be optimised. The same thing can also be achieved by pressure springs 15 having similar spring constants but different biases.

FIGS. 1 and 2 show the device in cooperation with the material web 3 and the abutment 8. The abutment 8 has a back-pressure structure 10 facing the sealing tool 7 and its rib 9. The back-pressure structure 10 may comprise a rubber sheet facing the material web 3. The abutment 8 can be of a conventional type or be designed as will be described below.

The material web 3, from which the container blanks 2 are formed, can be supplied in different designs. For instance, it is possible to let the material web 3 consist of a web folded longitudinally in the form of an M. A container blank 2 made from such a material web 3 will obtain two side walls from the two outer side portions of the material web 3 and a bottom wall from the central portion, folded in two, of the web. It is also possible to produce such a container blank 2 from a material web 3 comprising two separate webs 4, 5 and, arranged therebetween, a bottom-forming web 6 folded to a double-walled form, as shown in FIG. 1. Furthermore it is conceivable to provide the material web 3 in the form of a web, folded once, or by joining two separate webs. Bag-shaped container blanks can thus be produced from a thus arranged material web 3, which container blanks in subsequent operations can be formed to containers.

The material web 3 may comprise a container laminate with a core layer comprising a binder of polyolefin and a filler of mineral wool, such as chalk.

The material web 3 can be produced from a laminate with an inside-forming surface layer having a melting point which is lower than the melting point of the other layers of the laminate. By choosing a suitable sealing temperature and time, it will thus be possible to produce container blanks 2 from a web folded in the form of an M, or a web comprising two separate webs and, arranged therebetween, a web folded in two, without opposing outsides of the container blank 2 adhering to each other.

FIG. 5 illustrates an embodiment of the inventive device, in which the compensating means 14 comprising pressure springs 15 is arranged along edge portions 18 of the sealing tool 7 and the base element 12. Owing to the location of the pressure springs 15, larger and more durable pressure springs 15 can be used in case of a smaller number of springs, while at the same time the necessary compensation is provided, which means that the compensating means 14 achieves a longer life.

The function of an inventive device 1 will be described below with reference to FIGS. 1-4.

A material web 3 is fed to the device 1 for production of container blanks 2 and is arranged between the sealing tool 7 and the abutment 8.

The base element and the sealing tool 7 supported thereby via said compensating means are then applied to the material web 3 so that the rib 9 of the sealing tool 7 engages the same, which is shown in FIG. 2. The rib 9 of the sealing tool 7 presses the material web 3 against the abutment 8, which means that the material web 3 is subjected to pressure.

The heating means of the sealing tool 7 are adapted to heat the rib 9 to allow joining of the opposite wall portions of the material web 3 along the desired connecting portion by heat sealing. When the material web 3 is exposed to heat and the pressure from the rib 9 of the sealing tool 7, the different layers 4-6 of the material web 3 are joined along said connecting portion and form a container blank 2. After production of said container blanks 2, they are punched from the material web 3 so that neighbouring container blanks 2 are connected to each other to form a web of container blanks 2 (not shown). Waste material is removed and can be reused for producing new container material. The material web 3 is fed by rolling the punched web of container blanks 2 onto a roll (not shown).

In operation of the device 1 for producing container blanks 2, situations may arise where the sealing tool 7 and/or the base element 12 deviate from the initial setting of the device 1. The deviations from said initial setting can be caused by the repeated motion of the device and the sealing tool 7, wear on the parts of the device 1 or the fact that the heat from the heating means affects parts of the device 1.

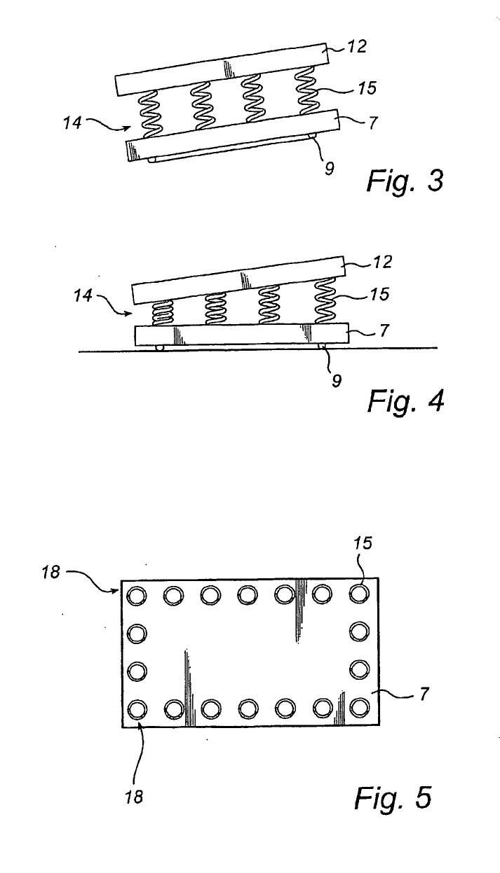

FIGS. 3 and 4 illustrate a situation where the inventive device has deviated from its initial setting.

FIG. 3 shows the device in its rest position and the base element 12 has been actuated so that it has deviated from a horizontal plane, along which the base element 12 is extended in the initial setting of the device. As a result, also the sealing tool 7 supported by said base element 12 will deviate from the horizontal plane.

It should be mentioned that the deviations from the horizontal planes are for reasons of clarity greatly exaggerated in the drawings.

FIG. 4 shows the device in a working position, in which the rib 9 of the sealing tool 7 engages a material web.

The compensating means 14 has started to function and ensured that the rib 9 of the sealing tool 7 along its entire length is made to abut against the material web 3, thereby ensuring the forming of a reliable connecting portion.

More specifically, the rib 9 of the sealing tool 7 will, when moving the inventive device from said rest position to said working position, initially engage, along only part of its extent, the material web 3. In response to this engagement, the pressure springs 15 of the compensating means 14 which are associated with this part of the rib 9 will be compressed, whereby alignment of the sealing tool 7 occurs. During the continued moving of the device towards the material web 3, said alignment will proceed until the rib 9 along its entire length has been made to engage the material web 3.

It will be appreciated that the deviation of the device from the initial setting may cause some of the pressure springs 15 of the compensating means 14 to be compressed more, and others less, which in turn means that the sealing pressure along the rib 9 of the sealing tool 7 will vary accordingly. However, the deviations are usually so small that these variations in sealing pressure are negligible.

It will be appreciated, as mentioned above, that the invention can also be realised with compensating means 14 in other forms than pressure springs 15; the compensating means 14 may consist of a resilient rubber sheet for instance.

Owing to the compensating means, the sealing tool 7 is not applied too forcefully to the material web 3, thus preventing the material web 3 from being damaged by the sealing tool 7. Moreover, the compensating means 14 also means that the sealing tool 7 is not applied too loosely to the material web 3, thereby preventing the layers of the material web 3 from not being correctly joined.

The compensating means 14 can also compensate for deviations of the material web 3. According to that described above, the pressure springs 15 will also be compressed in the case that a correctly set sealing tool 7 is applied to a material web 3 with deviations in thickness. In this case, the sealing tool 7 will first engage that part of the material web 3 which has the greatest thickness. The pressure springs 15 which are arranged at the engaging part of the sealing tool 7 will be compressed when the sealing tool 7 is pressed downwards. As a result, the sealing tool 7 will be angled in relation to the base element 12 corresponding to the surface structure of the material web 3, which means that the necessary sealing can take place although there are deviations in the material web 3.

A device 1 may comprise a plurality of sealing tools 7 which are arranged on one or more base elements 12, which means that the capacity of the device can be increased. The sealing tools 7 can be arranged in succession or side by side. In the case when a plurality of sealing tools 7 are arranged side by side, one wide or a plurality of materials webs 3 can be used. In the case that the sealing tools 7 are arranged in succession, one material web 3 can be used.

According to that described above, it is important for a required sealing pressure to be achieved during the engagement of the sealing tool 7 with the material web 3. It has also been described above how this sealing pressure is provided by means of a sealing tool 7 comprising pressure springs 15 which are compressed during the engagement of the sealing tool 7 with the material web 3. It will be appreciated that the desired sealing pressure can be lost if, for instance, one of the pressure springs 15 should be damaged. This would in turn, in operation of the inventive device 1, result in poor quality of the connecting portions provided by the sealing tool 7 in question, which could result in container blanks 2 that are not tight. According to an embodiment of the present invention (not shown), the device comprises to this end a pressure sensor (not shown). By comparing the actual contact pressure with a predetermined value, it is thus possible to discover defects, such as breakdown, in the compensating means.

It will be appreciated that a person skilled in the art can modify the above-described device 1 for producing container blanks 2 in various ways and still use the advantages of the various partial solutions.

The following can be mentioned as examples of modifications/variations:

The device concerns not only heat sealing of container blanks, but can also be applied in other sealing techniques, such as induction sealing and ultrasonic sealing.

It is also conceivable to design the inventive device so that the sealing tool has no rib, in which case the rib is instead formed on the abutment, to which the sealing tool is applicable, the material web being arranged therebetween.

It is also possible to design the abutment so as to have a rib complementary to the rib of the sealing tool shown in FIGS. 1-4, whereby two ribs of the described type are brought together, the material web being arranged therebetween.

The sealing tool of the inventive device can be arranged to engage the material web during simultaneous movement with the same to allow continuous production of container blanks. It is also possible to arrange the sealing tool for stationary engagement with the material web, whereby container blanks are produced in intermittent operation.

Several modifications and variations are thus feasible, and therefore the scope of protection of the present invention is exclusively defined by the appended claims.

1. A device (1) for producing container blanks (2) from a material web (3), which container blanks in the filled state form containers of a collapsible type, said device comprising
at least one sealing tool (7) with an extended rib (9), the sealing tool (7) being movable to bring the rib (9) into engagement with the material web (3) for joining opposite wall portions of the material web (3),
characterised by
a compensating means (14) for ensuring abutment of the rib (9) along its entire length against the material web (3).

2. A device as claimed in claim 1, wherein the rib (9) is arranged to form a connecting portion of the container blank (2) which at least defines a compartment of the container blank (2).

3. A device as claimed in claim 1 or 2, in which the compensating means (14) is arranged to provide a contact pressure against the material web (3), the contact pres-sure varying along the extent of the rib of the at least one sealing tool.

4. A device as claimed in claim 1, wherein the at least one sealing tool (7) is suspended from the compensating means (14).

5. A device as claimed in claim 1, wherein the compensating means (14) is a spring assembly.

6. A device as claimed in claim 5, in which the spring assembly comprises spring elements with mutually different spring constants.

7. A device as claimed in claim 5, in which the spring assembly comprises at least one pressure spring.

8. A device as claimed in claim 5, wherein the spring assembly is biased.

9. A device as claimed in claim 1, wherein the compensating means (14) is arranged along edge portions (18) of the at least one sealing tool (7).

10. A device as claimed in claim 1, wherein the device further comprises a base element (12), from which the at least one sealing tool (7) is suspended via said compensating means (14).

11. A device as claimed in claim 10, wherein a number of pins are arranged on the side of the sealing tool (7) which faces the base element (12) and the base element (12) comprises a number of through holes, the pins extending through said holes and said spring elements being arranged around the pins and positioned between the sealing tool (7) and the base element (12).

12. A device as claimed in claim 11, wherein the pins support stop washers at the ends extending through the holes of the base element (12).

13. A device as claimed in claim 1, wherein the device further comprises an abutment (8), which is arranged on the opposite side of the material web (3) to cooperate with the sealing tool (7) for joining opposite wall portions of the material web (3).

14. A device as claimed in claim 13, wherein the abutment (8) has a shape complementary to the sealing tool (7).

15. A method for producing container blanks (2) from a material web (3), which container blanks (2) in the filled state form containers of a collapsible type,
characterised by
arranging a material web (3) with wall portions, abutting against each other, between a sealing tool (7) and an abutment (8),
which sealing tool (7) comprises a rib (9) having an extent corresponding to the connecting portions of a container blank (2),
bringing said rib into abutment against the material web for clamping the same between said rib and said abutment,
compensating for the abutment of the rib so that the rib along its entire extent abuts against the material web, and
joining, by means of said rib, said opposite wall portions to each other along a connecting portion.

16. A method as claimed in claim 15, wherein said step of compensating for the abutment of the rib is per-formed by means of a spring assembly, from which said sealing tool is suspended and which in connection with the step of bringing the tool into abutment against the material web compensates for deviations in the initial setting of the tool.

17. A machine for producing container blanks (2) from a material web (3), which container blanks in the filled state form containers of a collapsible type,
characterised in that
it comprises a device as claimed in claim 1.
